(19) United States
(12) Patent Application Publication
(10) Pub. No.: US 2016/0199985 A1
(43) Pub. Date: Jul. 14, 2016

(54) SYSTEM AND METHOD FOR AUTOMATED AFFIXING OF DECORATIVE OBJECTS TO A SURFACE

(71) Applicant: Design & Assembly Concepts, Inc., Leander, TX (US)

(72) Inventor: Mark Ganninger, Leander, TX (US)

(73) Assignee: Design & Assembly Concepts, Inc., Leander, TX (US)

(21) Appl. No.: 14/991,703

(22) Filed: Jan. 8, 2016

Related U.S. Application Data
(60) Provisional application No. 62/101,006, filed on Jan. 8, 2015.

(51) Int. Cl. B25J 15/00; B44C 1/18; B25J 15/06; B25J 11/00; B25J 9/06

(52) U.S. Cl. CPC B25J 15/008; B25J 11/005; B25J 9/06; B25J 15/0616; B44C 1/18; Y10S 901/02

(57) ABSTRACT

Disclosed is an invention in the field of automated assembly. The present invention particularly relates to a system and method to attach items such as decorative materials to desired objects. The present invention automatically picks up and places decorative materials such as crystals or rhinestones on a three-dimensional (3-D) surface of an object utilizing a multi-axis robot. A digital file of the object is created that would represent the surfaces of the object, and decorative materials are then placed on the digital object in a design or pattern. Upon loading the physical object in the machine, a computer program designed to process the designs calculates the position, color, and size, for each decorative element or rhinestone. The user then loads the required decorative materials into the system and runs the system.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### STATEMENT OF FEDERALLY FUNDED RESEARCH

None.

### CROSS-REFERENCE TO RELATED APPLICATIONS

This application claims priority to: provisional U.S. Patent Application Ser. No. 62/101,006, filed on Jan. 8, 2015, entitled “System for Automated Affixing of Decorative Objects to a Surface” which provisional patent application is commonly assigned to the Assignee of the present invention and is hereby incorporated herein by reference in its entirety for all purposes.

### TECHNICAL FIELD

The present invention relates in general to the field of automated assembly. In particular, the present invention relates to automated affixing of decorative and ornamental materials to three-dimensional object.

### BACKGROUND OF THE DISCLOSURE

Decorative materials, such as sequins, ribbons, rhinestones and other glass crystals or elements have been incorporated onto various items ranging from household items and fixtures to clothing apparel and accessories. These decorative materials provide optical effects and aesthetic qualities. Further popularized in hip hop culture as “bling”, decorative materials may further refer to flashy, ostentatious or elaborate jewelry and ornamented accessories that are carried, worn or installed, such decorative features which have now become mainstream fashion items and are used on items such as cell phones, purses, clothing and other accessories. Decorative materials have also been incorporated into various objects beyond accessories, including consumer goods made of many different materials.

Attachment of parts such as decorative materials, such as rhinestones, includes primarily applying the objects to a surface by hand. Workers previously manually oriented and placed rhinestones or decorative materials in a setting, using a setting tool to adjust prongs over the decorative element. Over time, adhesives with flat-backed decorative materials were introduced. Other methods include producing injection-molded decoration articles having decorative materials arranged in the injection-molded article. Automated systems have been utilized to set a plurality of decorative materials in a continuous chain of interconnected settings, but such machines are limited in their design capabilities. Further, while these technological advances have allowed for automated application of decorative materials to flat surfaces, there remains a need in the art custom designed attachment of decorative materials to objects having three-dimensional surfaces.

### SUMMARY OF THE DISCLOSURE

The present invention addresses failings in the art by providing a system and method to attach items such as decorative stones or glass elements to three-dimensional objects. It is one object of the present invention to automatically pick and place objects such as crystals or rhinestones on a three-dimensional (3-D) surface of an object utilizing a multi-axis robot. It is another object of the present invention to apply decorative materials or rhinestones to a 3-D surface. A 3-D digital file of the object is created that would represent the surfaces of the object. It is a further object of the present invention that the digital images of the decorative element or rhinestone are placed on the digital object in a design or pattern. The digital decorative materials or rhinestones can be of different colors, types, and sizes. Once the digital design is created, the user loads the physical object in the machine. From the digital design, a software system designed to process the designs calculates the position, color, and size, for each decorative element or rhinestone. The user then loads the required decorative materials into the magazines or feeders of the system. Once loaded a user runs the system.

In one aspect, the assembly of such stones or glass elements occurs on a surface. The present invention may further be utilized to apply decorative materials to a 3-D surface. It is therefore an object of the present invention to provide a system to programmatically apply the parts to the object in 3-D space. Known methods are only able to apply crystals with adhesive to objects that are flat. Users typically must manually apply the parts and adhesive to a 3-D surface object.

Current application of crystals or rhinestones to 3-D objects is a time consuming process that is done by hand, is not repeatable from a mass production standard, is expensive, and does not lend itself to mass production. The present invention operates at an accurate level and is faster than hand placed parts. The two dimensional (2D) systems known in the art for decorative element or rhinestone application are faster but cannot apply onto 3-D surfaces or apply crystals that require adhesive application.

It is therefore an object of the present invention to provide an apparatus for affixing decorative material on a three-dimensional object, comprising: a robotic arm assembly having a placement head; one or more retrieving heads extending from the placement head of the robotic arm assembly; one or more adhesive heads extending from the placement head of the robotic arm assembly; a base plate; one or more magazines further comprising one or more decorative materials; and a controller in electronic communication with the robotic arm assembly via a communication link further comprising a computing device, memory storing computer-executable instructions, and one or more processors. The robotic arm assembly may be a six-axis robotic arm. The retrieving head assembly may further comprise a vacuum assembly, and the adhesive head assembly may further comprise a reservoir of adhesive. One or more magazines may comprise different decorative materials for affixing to the object. Further, the decorative materials can be arranged in the magazine in an array having a predetermined location in order for the robotic arm assembly to pick up, or retrieve, the decorative materials. The decorative materials located in the magazine may further be arranged in a feeder arrangement.

It is another object of the present invention to provide a method for placement of decorative materials on a three-dimensional object, comprising: positioning a three-dimensional object on a base plate; applying an adhesive to the three-dimensional object at a preconfigured location via a robotic arm assembly; and affixing a decorative material to the three-dimensional object at said preconfigured location via the robotic arm assembly. The three-dimensional object may be further secured into position on the base plate by a pedestal elevating the object off the base plate. Additionally, the present invention further comprises inputting a three-dimensional graphical model of the three-dimensional object into a controller comprising a computing device graphical model of the three-dimensional object into a controller comprising a computing device, memory storing computer-executable instructions, and one or more processors for executing said computer-executable instructions for operating a robotic arm assembly. Graphical renderings of decorative materials may be placed onto the graphical model of the three-dimensional object. In one aspect, the application of the adhesive further comprises applying computationally-sized droplet located where one decorative material is to be attached. Alternatively, the application of the adhesive is made to the entire three-dimensional object.

It is another object of the present invention to provide a system, comprising: a controller comprising a computing device, memory storing computer-executable instructions, and one or more processors for executing said computer-executable instructions for operating a robotic arm assembly for affixing adhesive and decorative materials onto a three-dimensional object, said operating occurring during performance of a preconfigured gesture that changes the position of the robotic arm assembly during the performance of the gesture; a base plate for supporting a three-dimensional object and robotic arm assembly; a magazine of decorative materials located upon said base plate; and a robotic arm assembly comprising one or more retrieving heads and one or more adhesive heads, wherein the one or more adhesive heads are operable via the controller to affix adhesive at one or more desired locations upon the three-dimensional object, and wherein the one or more retrieving heads are operable via the controller to retrieve the decorative materials from the magazine and position the decorative materials on the desired location having adhesive applied. In one aspect the robotic arm assembly may be a six-axis robotic arm. The computer-executable instructions may comprise a three-dimensional graphical model of the three-dimensional object, and the computer-executable instructions further comprise user data input. A magazine of decorative materials is located in reach of the robotic arm assembly, wherein the robotic arm assembly is capable of retrieving the desired decorative materials via a retrieving head using computer-executable instructions for determining the location of the decorative materials. Additionally, there may be more than one magazine comprising decorative materials.

The present invention may further provide methods for affixing decorative materials on an object utilizing a robotic arm equipped with one or more feeding modules for holding and feeding decorative materials of different shapes, colors and sizes. The robotic arm is capable of being directed around a 3-D object for purposes of affixing the decorative materials. The plurality of decorative materials allows the attachment apparatus to affix custom designed patterns and colors at a rapid rate.

The present invention further provides a controller device comprising software which allows for a user to create designs to be implemented onto an object. The controller comprises may include storage for designs and artwork available to create designs based upon the available decorative materials. The controller allows for various functions including design, measurement, review and modification of the applicable design for attaching decorative materials to an object. The controller may be connected to a computer where software communicates with the controller to activate and control the application of decorative materials to an object.

The details of one or more embodiments of the present invention are set forth in the accompanying drawings and description below. Other aspects, features and advantages will be apparent from the description and drawings.

### BRIEF DESCRIPTION OF THE DRAWINGS

The foregoing and other objects, features, and advantages of the disclosure will be apparent from the following description of embodiments as illustrated in the accompanying figures and drawings.

FIG. 1 depicts an isometric view of the system of the present invention, including the robotic arm and platform oriented over the computing device(s) and controller, within an enclosure.

FIG. 2 depicts a side perspective view of the system of the present invention, including the robotic arm and platform oriented over the computing device(s) within an enclosure.

FIG. 3 depicts an opposing side perspective view of the system of the present invention set forth in FIG. 2.

FIG. 4 depicts an isometric view of the robotic arm assembly and accompanying tray of decorative materials with an object presented for affixing the decorative materials.

FIG. 5 depicts the robotic arm of an exemplary apparatus performing attachment of decorative materials.

FIG. 6 depicts a tray comprising multiple decorative materials.

FIG. 7 depicts subcomponents of the robotic base and adhesive hand or end-of-arm assembly.

FIG. 8 depicts an assembled adhesive hand or end-of-arm assembly.

FIG. 9 depicts the hand or end-of-arm assembly with adhesive assembly and retrieving assembly.

FIG. 10 depicts subcomponents of an adhesive assembly of the present invention.

FIG. 11 depicts an assembled adhesive assembly of the present invention.

FIG. 12 depicts subcomponents of a retrieving assembly of the present invention.

FIG. 13 depicts a platform comprising an object for treatment.

FIG. 14 depicts an expanded view of a platform comprising an object for treatment, showing the mechanism for object retention within the system.

FIG. 15 depicts a side perspective view of the platform of FIG. 14.

FIG. 16 depicts a flow diagram of a method of the present invention.

FIG. 17 depicts a final product developed utilizing the system of the present invention.

### DETAILED DESCRIPTION OF THE DISCLOSURE

While the making and using of various embodiments of the present invention are discussed in detail below, it should be appreciated that the present invention provides many applicable inventive concepts that can be embodied in a wide variety of specific contexts, goods, or services. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present invention will now be described more fully hereinafter with reference to the accompanying figures and drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, compositions, processes, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

For the purposes of the present invention, a robotic arm assembly is a mechanical robotic arm usable for an industrial robot adapted to freely bend to realize a pattern of movement having a high ability of movement, excellent reachability and high accuracy by virtue of a comparatively small amount of rotational movement and a comparatively large amount of translational movement. The robotic arm has cylindrical arm flexibly connected to one after another via joints, and the arm portions comprise one upper arm, at least one intermediate arm and one lower arm. Coupled to the lower arm is a hand, or end-of-arm tool which is capable of performing certain predetermined tasks. As an exemplary embodiment, the robotic arm may be an A 6-axis robot, such as a FANUC LR MATE 200ID, is configured to convert given position data, which is expressed by fixed three-dimensional orthogonal coordinates, to angle data for a rotation joint of the robot and move an end effector (i.e., hand) of the robot to a position indicated by the position data. The robot may further comprise a robotic arm wherein the hand is an end-of-arm tool with a retrieving head and a glue head. Each head has its own unique tool coordinate system. This tool coordinate system is switched depending on if glue is placed or a decorative material is placed. This coordinate system enables the tip to be in the same position data space depending on the process.

Robot arms used in such systems are jointed so that the tool can be moved to any position within a three-dimensional envelope, commonly referred to as the working envelope of the arm. The actual movement of the joints of the arm is accomplished by motors or other actuators. The operation of the motors is usually accomplished under computer control. In this regard, in state-of-the-art robotic systems, the arms are controlled by computer means which include one or more processors for effecting movement of the arm to various positions within the working volume in accordance with predetermined teachable and repeatable programs. To accomplish such control, the joint motors frequently have associated with them encoders to provide signals indicative of joint position. These signals are operated on by mathematical computation means in the system's computing device so that the exact position of the robotic arm assembly within the working volume is determined to insure accurate arm positioning when the joint motors are operated to move the arm to another position within the working volume.

For the purposes of the present invention “decorative materials” includes, but is not limited to: gems, gemstones, rhinestones, lead crystal and glass pieces, polished and unpolished glass crystals, faceted crystal and glass pieces, wood, beads, plastics, stones, painted objects, gold and other such various metallic particles metal compositions of various shapes, forms, sizes, and types. Decorative materials may also include more complex items, such as LEDs, or lighting componentry, sensor materials, and the like.

Decorative materials may further include SWAROVSKI® elements and crystals. Swarovski elements are created by the Swarovski Company, and they are primarily made from lead crystal, which is glass with lead added to it to produce a higher degree of shine. Current Swarovski rhinestones typically feature between 8 and 14 facets, and their precision cutting method creates stones that have an enhanced brilliance and reflective quality. Rhinestones may also be called Austrian crystals and feature a wide variety in choices. Czech rhinestones or glass elements refer to a type of decorative material that is made from pure glass or from lead crystal. These rhinestones have up to eight facets, with one large, flat central facet surrounded by smaller facets. This type of cut creates a dull stone when compared to the Swarovski rhinestones. Czech rhinestones also have less lead in the glass, resulting in a less sparkling gem. The decorative materials may be flat-backed or faceted, provided that the decorative materials are able to be affixed.

Turning to the present invention, a preferred embodiment comprises a system having a device for obtaining decorative materials from a reservoir, such as a tray or magazine, and placing them upon an object. The decorative materials are presented on the tray in a set position, such as an array, wherein the robotic arm comprising a vacuum head retrieving assembly is capable of picking up the desired decorative material for placement on the object. In an alternative embodiment, a magazine comprises a feeder, such as an ammunition clip, wherein the decorative material is picked up by the robotic arm, and another decorative material is then presented from underneath, or distally, from the decorative material removed. In yet another embodiment, the tray comprises a tape or array of decorative materials affixed to a material, yet capable of being removed by the robotic arm's retrieving assembly.

The present invention comprises a robotic arm having a chassis carrying a movable arm and head for placement of decorative materials that is adapted to operate in multiple planes to engage the decorative materials onto one or more surfaces of the object. In operation, the robotic arm is capable of positioning one or more decorative materials, having a plurality of magazines, utilizing a metal vacuum tip having a spring actuator capable of grasping and positioning the decorative materials. In another embodiment, the vacuum tip is concave in shape to conform to the shape of the decorative element, in whole or in part, to enhance the suction effect. In yet another embodiment, the vacuum head is comprised of flexible material for forming around the decorative element.

In another embodiment, a separate head on the robotic arm comprises an adhesive application function for dispensing adequate amounts of adhesive on the surface of the object. Applicable adhesives further include, but are not limited to, reactive or non-reactive adhesives, including drying adhesives, pressure-sensitive adhesives, contact adhesives, hot adhesives, one-part or multipart adhesives, and UV adhesives. The adhesive is placed upon the object, upon which the decorative element is applied to the position where the adhesive is applied. The dispensing head dispenses adhesive through a needle tip. A precision adhesive dot is applied for each decorative element in the amount calculated based upon the size, shape and other orientation of the decorative element. In an alternative embodiment the three-dimensional object may be pre-treated with adhesive, or covered broadly with adhesive on the surfaces intended to be treated.

In another embodiment, a computer assists in creating and implementing the decorative element design to be placed upon the object of interest. The software or computer-based features of present invention is described herein with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a network should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a wireless network should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The system configuration of the robotic arm comprising the placement and affixing heads is driven by a computing device which provides imaging capability and may be transmitted to the robotic arm for carrying out the attachment of the desired decorative materials for the desired design on the object of interest. User creates a 3-D surface model of the part that is going to have the objects placed on.

Created in 3-D CAD software, or other known modeling software, and exported in a 3-D surface format either IGES, STL, or OBJ file formats, a file is imported into the computer program instructions via a communication link or network. A texture map image of a design can also be imported into the computing device. This image can then be positioned over the 3-D object and wrap onto the 3-D surface. A user can then select the size and color of the decorative material or object to be placed on the object. The user can match the texture map image or they can free hand a design on the 3-D surface. Once a user selects the object, the decorative material is now attached to the mouse cursor, and the decorative material or object is a 3-D surface file that is used for representation of the object. The decorative material allows for attaching to the products 3-D surface and allows the computing device to perform interference detection so that an object cannot be placed on another object. The system further allows for the attachment of the decorative material or object to attach to the product surface via an adhesive application. The decorative material or object is programmed with a normal vector that is used as the attachment point. This normal vector is what attaches to the 3-D surface and defines the decorative material or objects orientation. When the user moves the decorative material over the 3-D surface, the decorative material attaches to the surface and the user can move the decorative material into position. Once the user is satisfied with the position of the decorative material the position is programmed and the decorative material remains on the 3-D surface.

The user then repeats the process with the same size and color decorative material or selects a different size or color. The user repeats this process until the design is complete. Other features of the system of the present invention include the ability to place multiple decorative materials in an area as well as moving or changing existing decorative materials. Further the system's programmable features allow a user to rotate the view of the image to observe the rendered 3-D object from any perspective.

The robotic arm's controller has a control unit, an imaging unit, a distance measuring unit, a network interface unit. The computing device has a computer readable medium capable of dragging stored decorative materials corresponding to the applicable magazine, or trays, of decorative materials available to the robotic arm. Designs may be incorporated via known available means, and the image is converted to a workable graphical representation of the object to be decorated. The design capability allows for the desired patter or colors of the decorative materials to be attached to the object. Upon completion of the design of the decorative element placement, the control unit receives, via a bus, the design to be implemented. This dynamic manipulation is part of the computer program instructions. The export creates a file set the includes the X,Y,Z, U(Yaw), and V (Pitch) positions of the decorative material in 3-D space relative to the 3-D objects coordinated system. W (Roll) is not needed for the placement of these objects but can be easily added if a non-symmetrical object is used. Each decorative material position has an associated color and size associated with it. This information is used by the robot system to determine which magazine position to pick the decorative material from. The color file is used to determine the color decorative materials to load in the magazine.

The computer program instructions further provide for the robotic arm to detect collisions or overlaps between two decorative materials, and will further sense and alert to such collisions or overlaps.

In one embodiment information is passed to the controller and robotic arm assembly via the communication link. The robot will dynamically adjust the W orientation for optimum orientation of the robotic arm for the particular place. In one embodiment, the robot coordinate system (an X, Y, Z, U, V, W user coordinate system) is set up such that the coordinate system for the product in the computer program instructions matches the user coordinate system. The computing device reads in the X, Y, Z, U, & V data for the first decorative material.

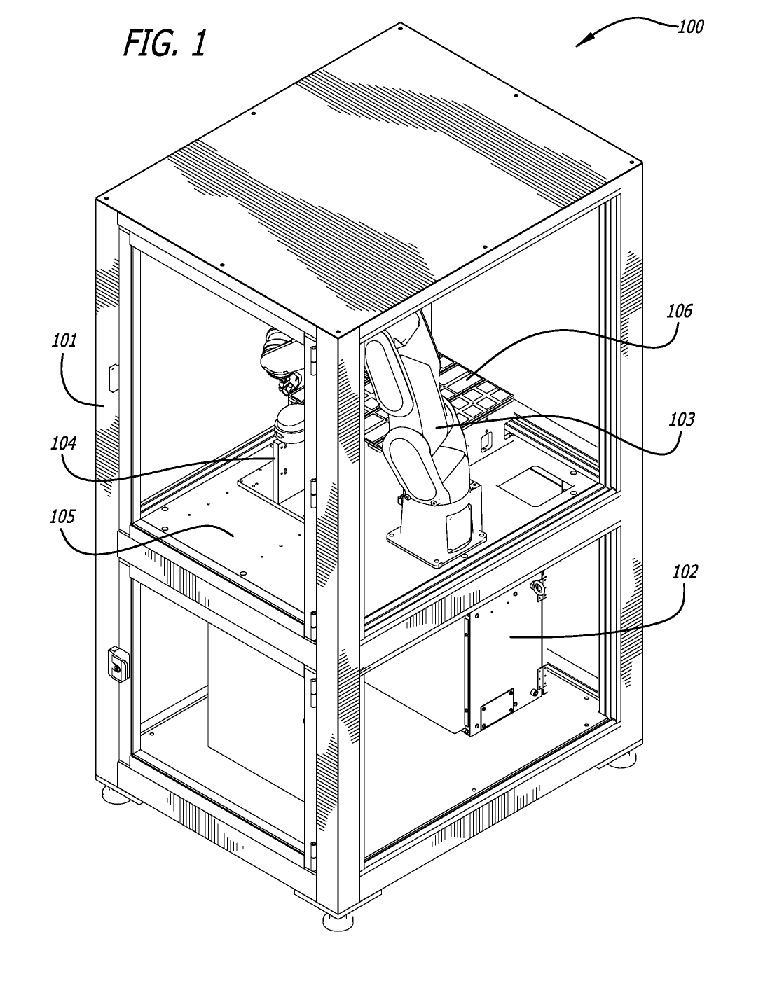

Certain embodiments will now be described in greater detail with reference to the figures. Referencing FIG. 1, an isometric view of a system of the present invention 100 is provided having an enclosure 101 housing a base 105, wherein a multi-axis robotic arm assembly 103 is attached to the base 105. A pedestal or platform 104 is utilized for placement of the target object within the enclosure 101. A tray, or array of trays, 106 comprising one or more magazines or feeders with decorative elements are placed within reach of the robotic arm 103. A computing device 102 comprising a controller and communication link operates the robotic arm 103. The system of the present invention comprises a robotic arm capable of movement around the object to be treated with decorative materials.

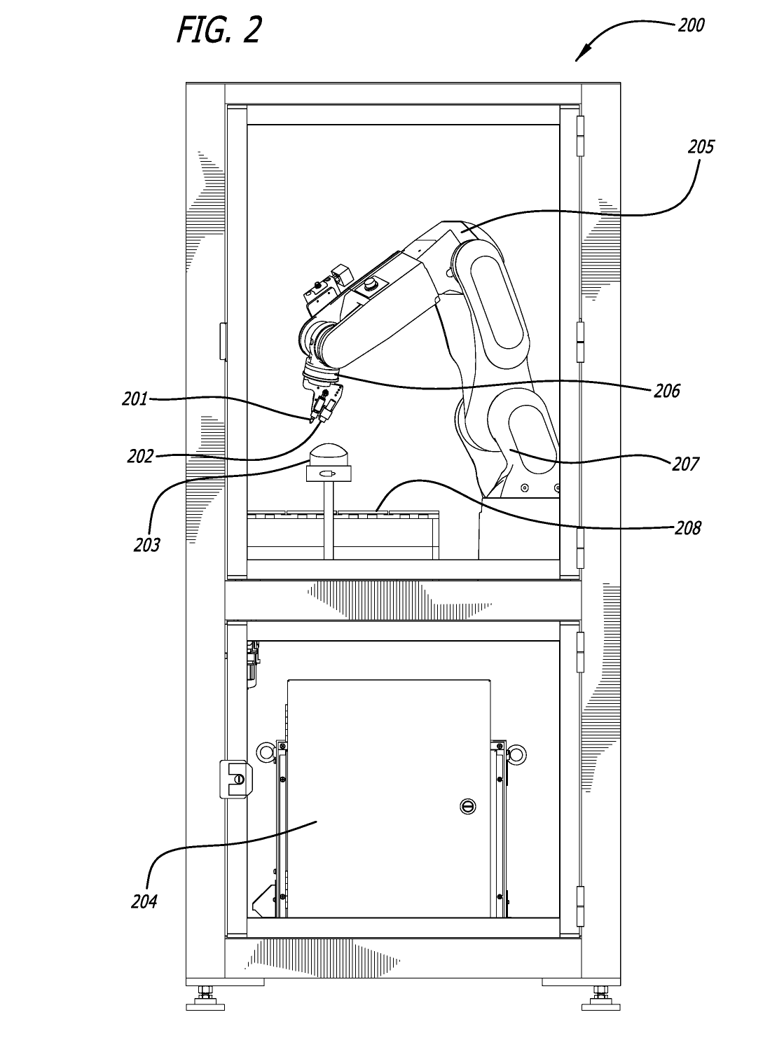

FIG. 2 provides a side perspective view 200 of the system of the present invention. A robotic arm is positioned within an enclosure. The robotic arm comprises multiple axis points, upon which is attached the rotatable placement head 206. The robotic arm chassis carries a moveable placement head 206 comprising an adhesive head 202 and a retrieving head 201 adapted to first apply adhesive at a pre-determined position, and to second position decorative materials upon an object. The placement head is a rotatable member 206 which is attached to the arm of the robot and is capable of grasping objects via a vacuum retrieving head 201. The multiple axis points of the robotic arm 205, 206, 207 allow for the robotic arm to maneuver around and object 203 in order to affix decorative materials on the object. The decorative materials are presented in a tray 208 having one or more magazines at predetermined locations retrievable by the robotic arm as needed. A computing device 204 having programmable computer instructions provides for operational aspects of the robotic arm to retrieve decorative materials, apply adhesive to the predetermined location on the object, and affix the decorative material to the object at said location.

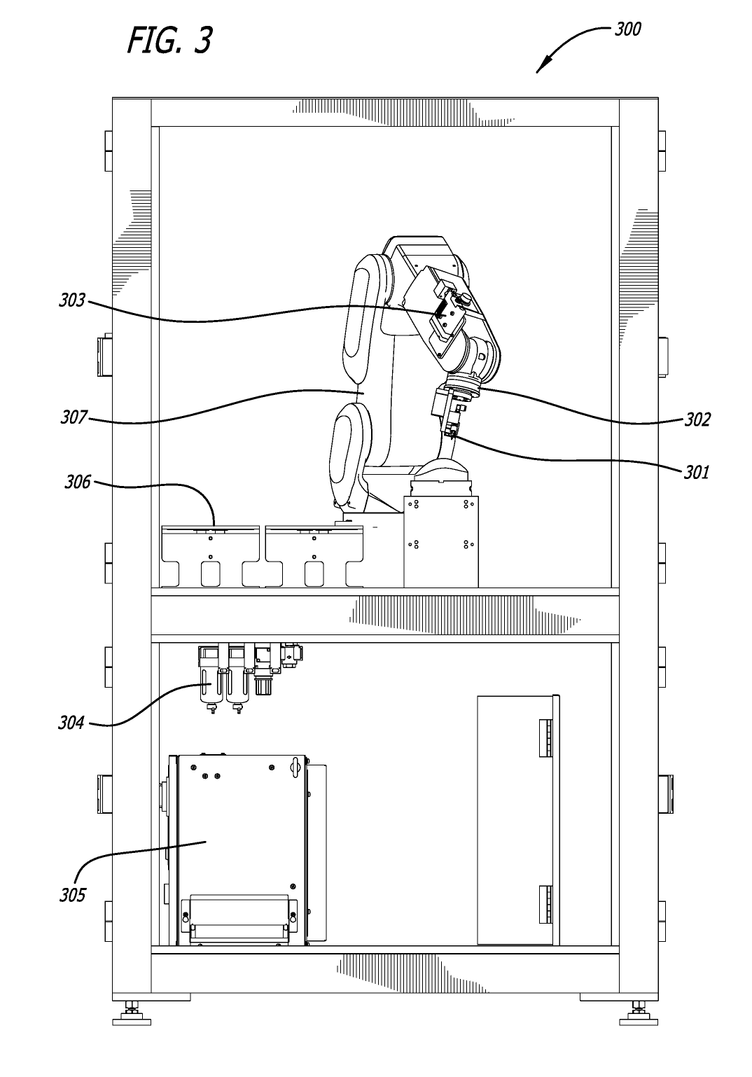

Referencing FIG. 3, an opposing side perspective view of the system 300 is presented wherein the rotatable placement head 302 of the robotic arm 307 comprises a vacuum-based retrieval head 301. A vacuum generator 303 is operably connected to the robotic arm 307 to provide vacuum suction to the retrieval head 301. Presented on the base plate is a tray 306 comprising one or more magazines of decorative materials, capable of being retrieved by the retrieval head 301, which is further capable of placement of the decorative material on the object by the robotic arm assembly operated by the controller 305 controller comprising a computing device, memory storing computer-executable instructions, and one or more processors for executing said computer-executable instructions for operating a robotic arm assembly for affixing adhesive and decorative materials onto a three-dimensional object, said operating occurring during performance of a preconfigured gesture that changes the position of the robotic arm assembly during the performance of the gesture. In the event air quality issues are required for treatment of the object, air purifiers 304 may be implemented for the system.

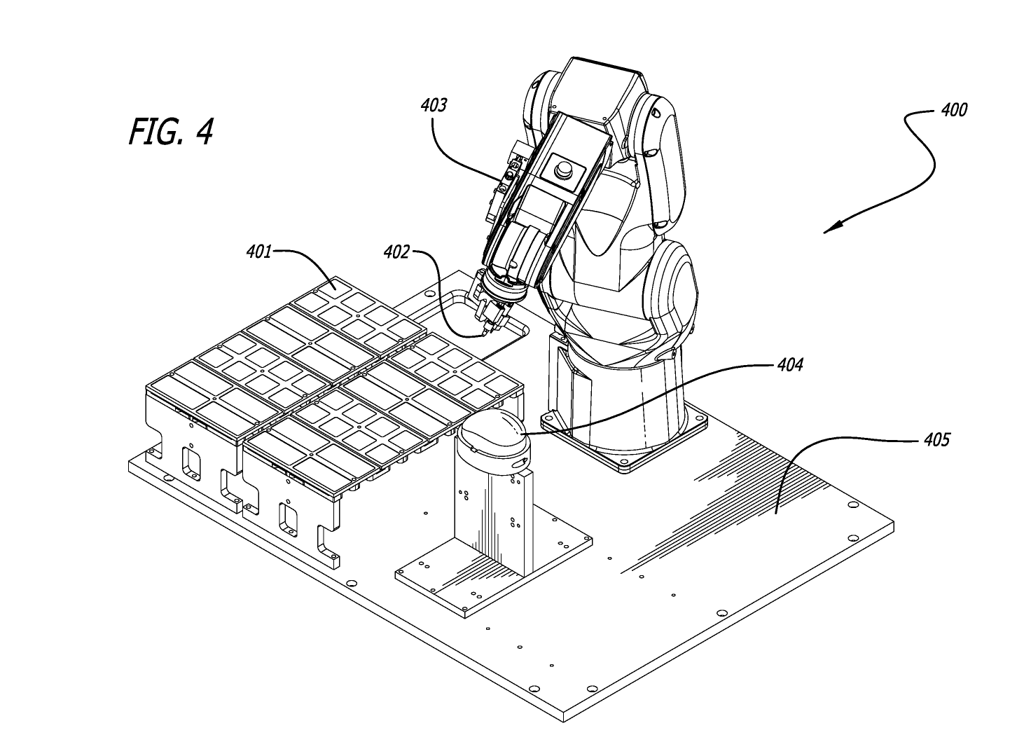

Referencing FIG. 4 the robotic arm 400 secured upon a base plate 405 is capable of retrieving desired decorative materials from a magazine 401 containing the applicable decorative material. The robotic arm 400 is capable of being maneuvered to the magazines 401 to retrieve a decorative material via the retrieval head 402 having a vacuum generator 403, and affix the decorative material upon the object 404. The robotic arm first addresses the object of interest by interpreting the computer program instructions.

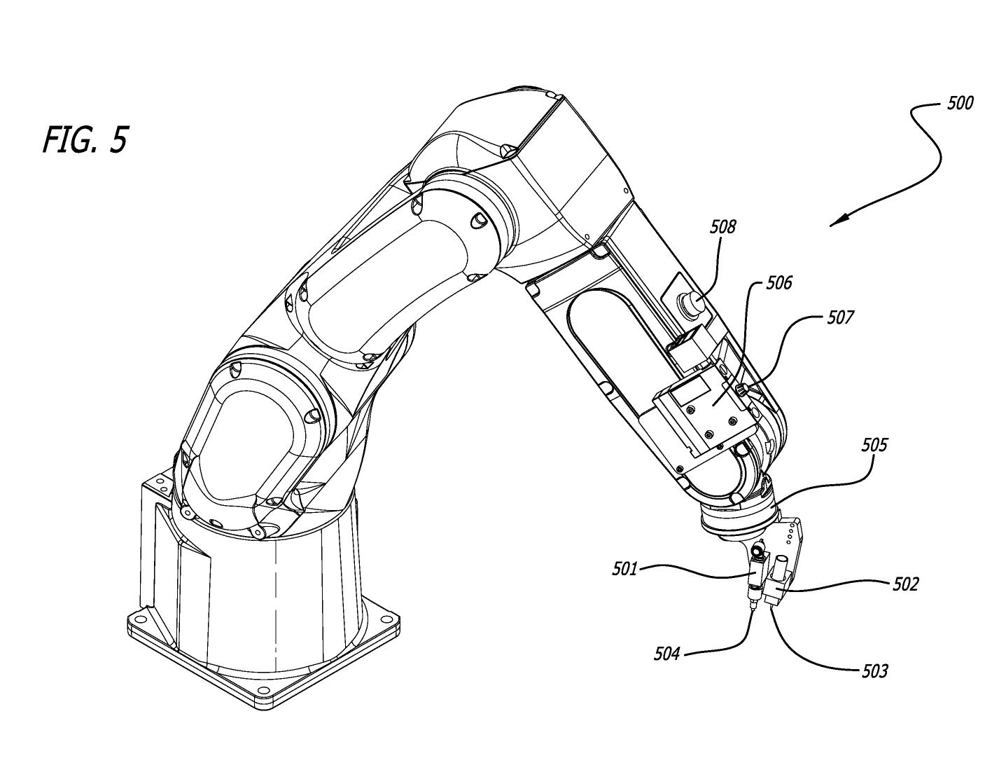

An expanded view of the robotic arm is presented in FIG. 5 500. In one embodiment the robotic arm comprises a separate head for application of glue or adhesive 503. In another embodiment, the placement head comprises a retrieval head 504 and an adhesive head 503 disposed within a mounting block 502, wherein the rotational and moveable capability of the robotic arm 500 provides for a first step of applying a computationally-sized droplet of glue or adhesive, followed by a rotational step by the robotic arm placement head axis 505 positioning the retrieval head 504 for placing the decorative element upon the deposited glue or adhesive. The retrieval head comprises a vacuum assembly 501 wherein suction is provided via a vacuum generator 506 having adjustable features 507, 508. A first step adhesive application occurs with the adhesive head 503, placing the applicable adhesive size where the decorative element is to be attached to the object. A second step of affixing the decorative element then occurs following the application of the adhesive application. The robotic arm 500 may provide multiple adhesive steps at once to optimize the efficiency of adhesive application prior to decorative element affixing steps. In another embodiment, the arm comprises both the retrieval and adhesive extensions, and will be capable of holding the element while applying the adhesive, then placing the element at the programmed point.

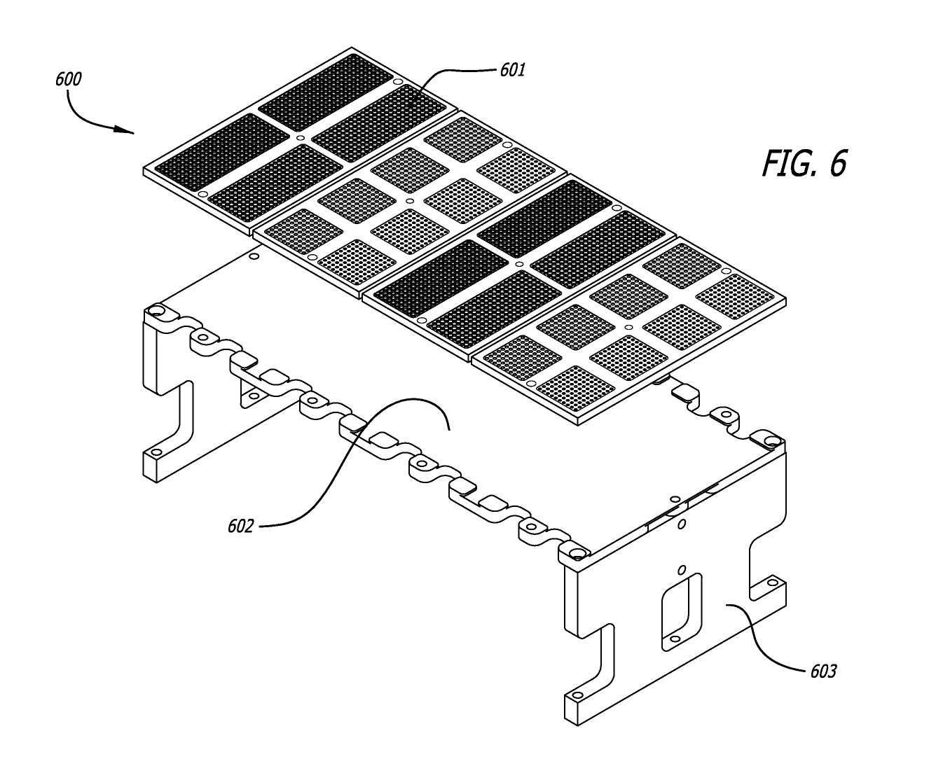

FIG. 6 provides additional detail of the tray 600 of the present invention, which supports one or more magazines 601 wherein decorative materials are positioned in a predetermined manner, thus capable of being retrieved by the retrieval head of the robotic arm. The tray 600 is placed upon a platform 602 having legs 603 attached to the base plate of the system. In an alternative embodiment, the tray comprises magazines which feed the decorative material, similar to an ammunition clip, wherein a new decorative material is presented at the same location as the previously retrieved decorative material. The feeder magazines may be similarly arranged on the tray 600, allowing for multiple types of decorative materials as may be desired.

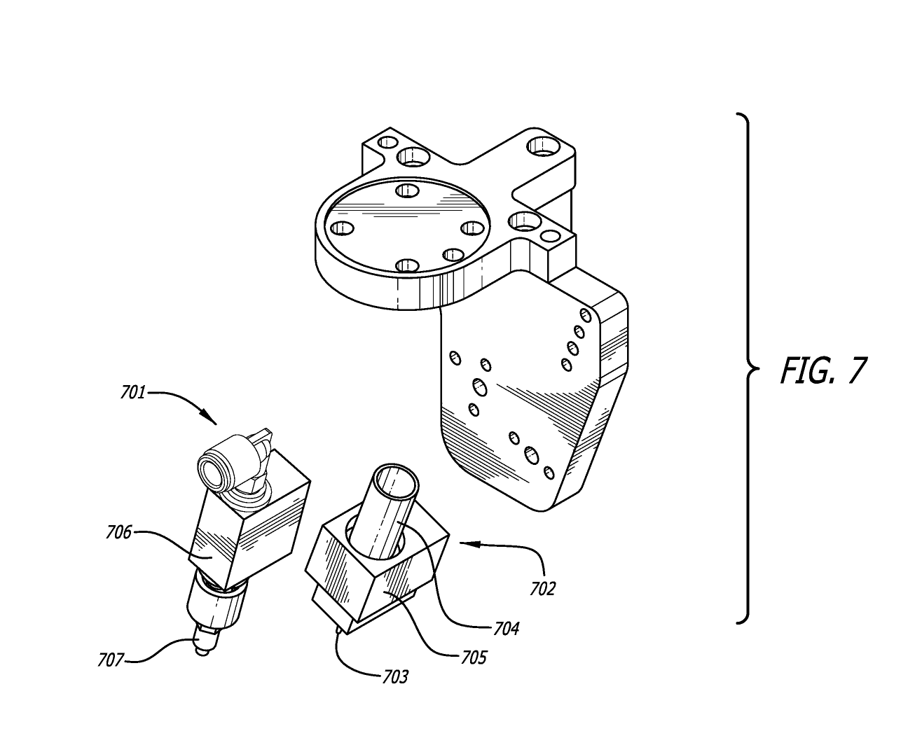

FIG. 7 provides and expanded view of components of the robotic arm, including a robotic arm mount plate, vacuum assembly 701 of the retrieval head, and adhesive assembly 702 of the adhesive head. The adhesive assembly comprises a reservoir for adhesive 704, and application tip 703, and mount block 705 for applying computationally determined adhesive amounts at the desired location on the object. The vacuum assembly 701 similarly comprises a computationally driven vacuum, having predetermined settings for retrieving decorative materials for placement upon an object.

The vacuum componentry comprises a head 707 and actuator nozzle 706 in fluid communication with a vacuum generator (not shown).

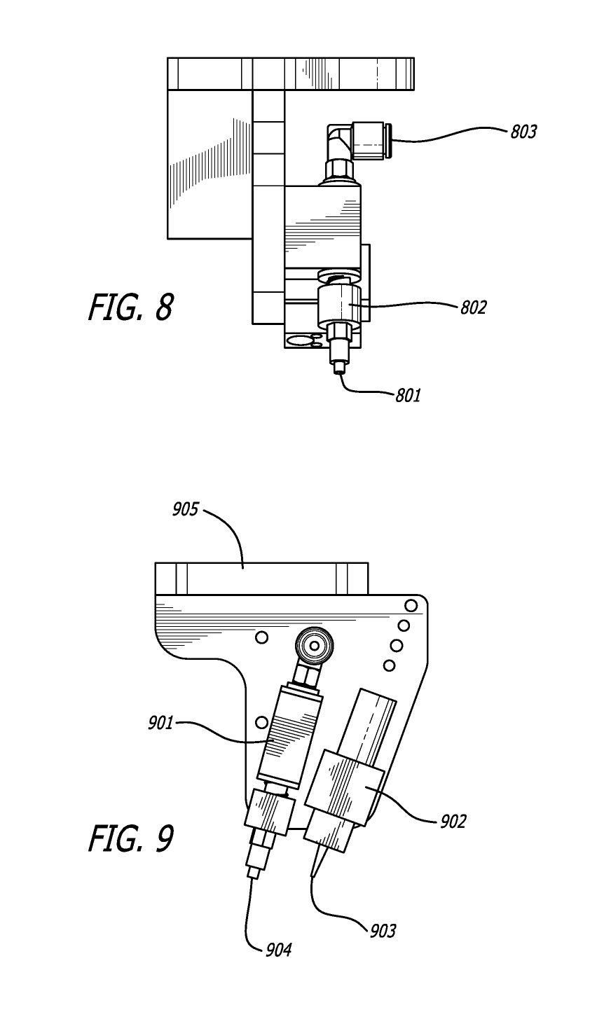

FIG. 8 presents an expanded view of the vacuum assembly of the retrieval head having an outlet 803 in fluid communication with the vacuum generator (not shown). The nozzle 802 is actuated to allow the retrieval head 801 to utilize suction for retrieval of decorative materials. FIG. 9 presents the complete placement head rotatably connected to the robotic arm via the axis 905. The vacuum assembly 901 of the retrieval head 904 is provided as well as the adhesive head 903 secured by the mounting block 902.

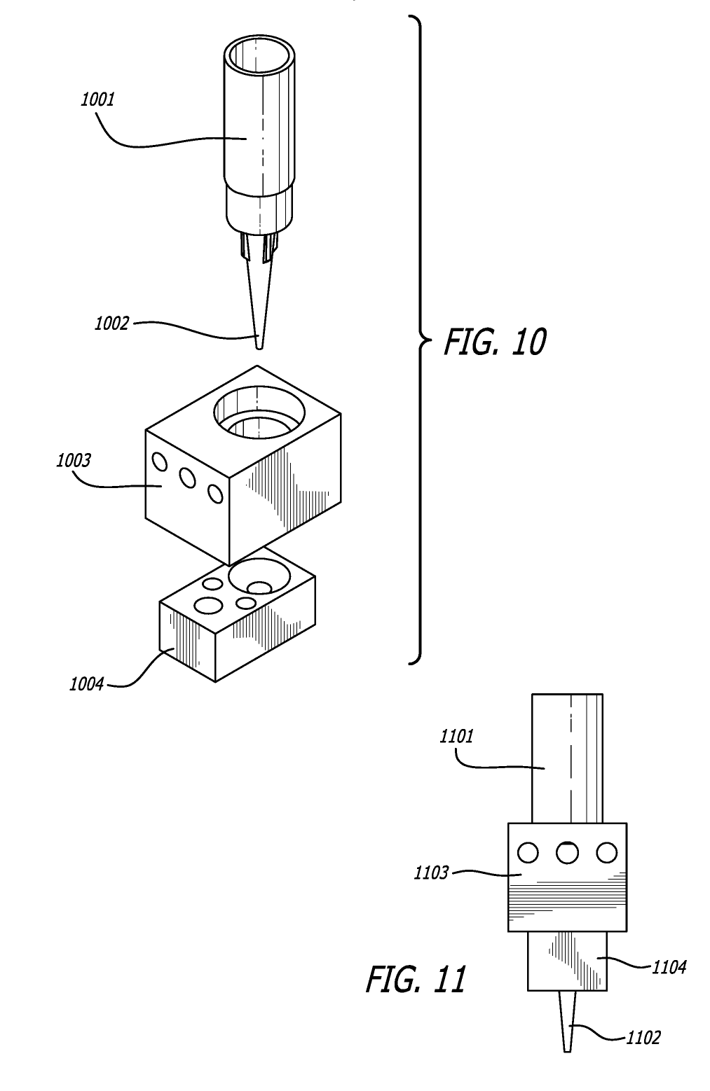

FIG. 10 presents an exploded view of the components of the adhesive head, comprising a reservoir 1001 and application tip 1002 presented through a mounting block 1003. A nozzle guide 1004 is further implemented, through which the application tip 1002 is positioned. FIG. 11 presents the fully assembled portion of the adhesive head having the reservoir 1101, mounting block 1103, nozzle guide 1104 and application tip 1102.

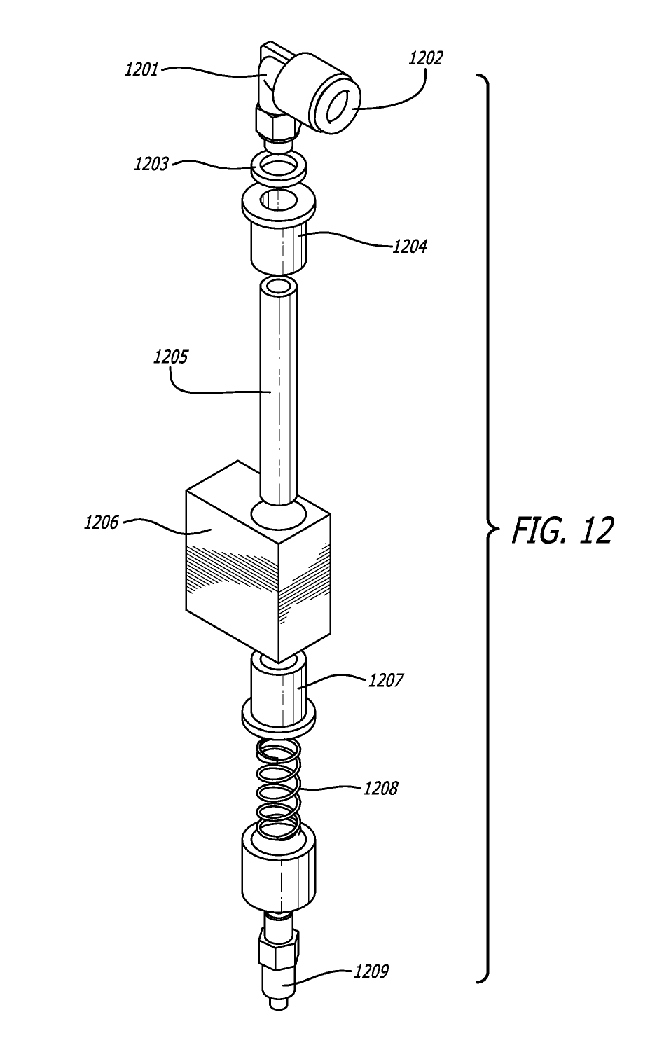

FIG. 12 presents the components of the vacuum assembly of the retrieval head. A vacuum fitting 1202 provides fluid communication to the vacuum generator, having an elbow assembly 1201 connected to a flanged bushing 1204, washer 1203, tubing 1205, which runs through the mounting block 1206, wherein a flanged bushing 1207 is then connected to a spring 1208 and vacuum stop capable of actuation as computationally controlled. The retrieval tip 1209 is then capable of retrieving decorative materials via vacuum suction.

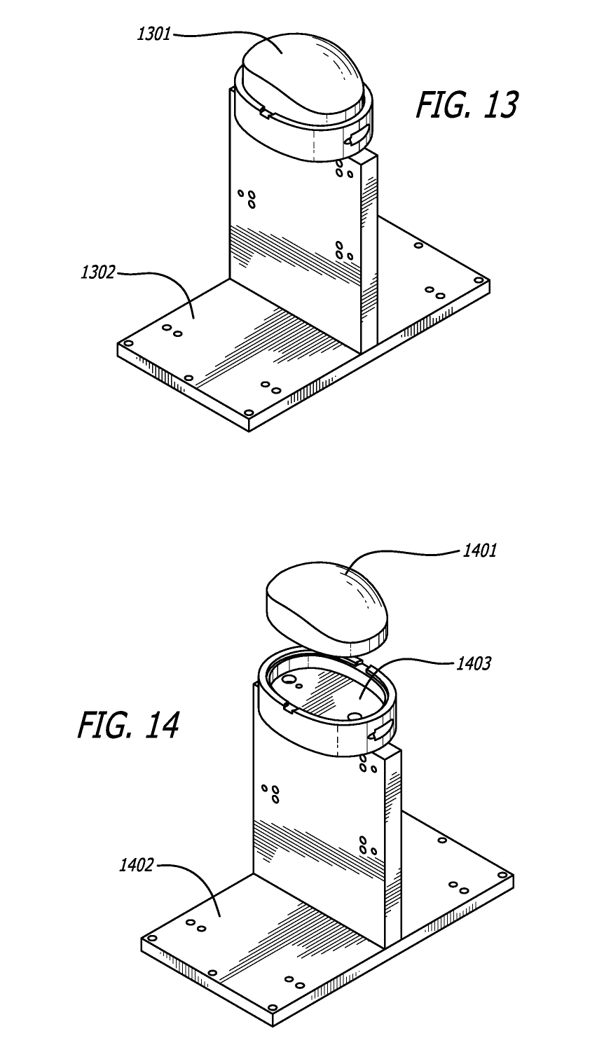

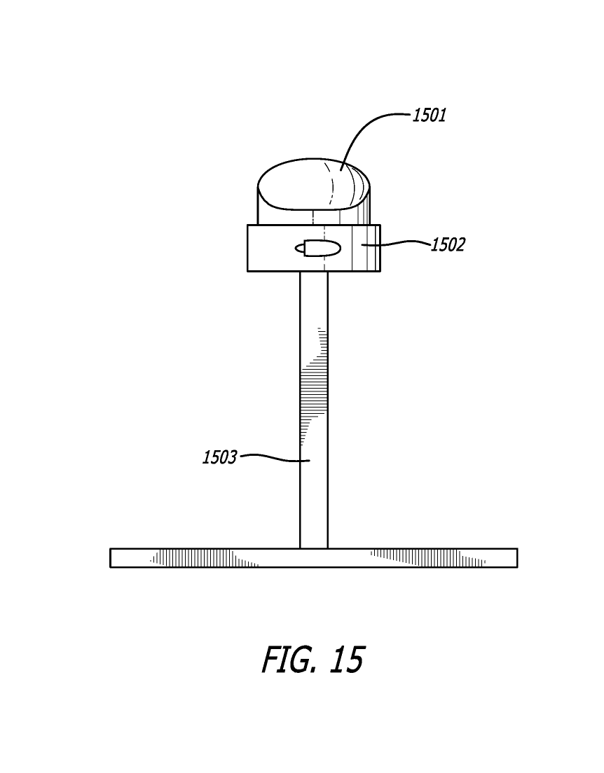

FIG. 13 presents an object 1301 to be treated with decorative materials placed upon a platform 1302 affixed to the base plate. The object 1301 is computationally located within the system for the robotic arm to then treat with decorative materials. As shown in FIG. 14, a housing 1403 is required to fasten the object in a manner where application of adhesive and affixing of decorative materials do not shift the object's 1401 position as it is computationally located on the platform 1402. FIG. 15 presents a side perspective view of the platform 1503, affixed to the base plate, having the housing 1502 which secures the object 1501 for treatment by the system of the present invention.

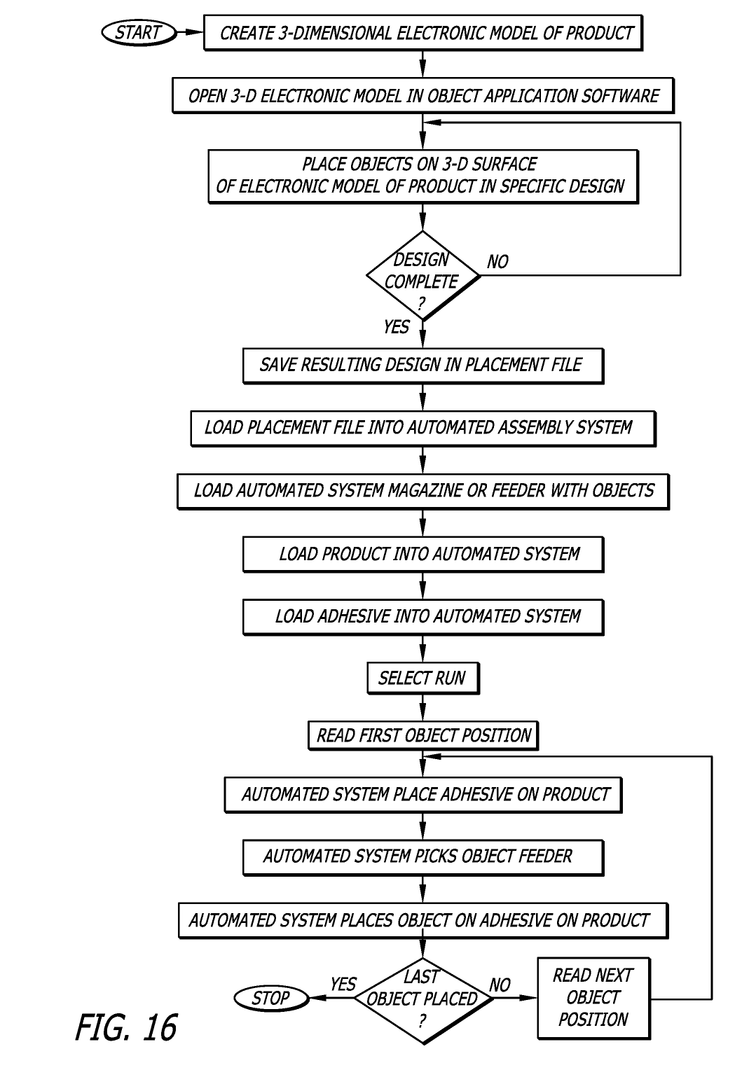

The method of the present invention is further described in FIG. 16. Via a computing device, a user inputs information to create a three-dimensional (3-D) electronic model of a product. In 3-D computer graphics, 3-D modeling is the process of developing a mathematical representation of any three-dimensional surface of an object via specialized software. 3-D modeling software is a class of 3-D computer graphics software used to produce 3-D models. Individual programs of this class are called modeling applications or modelers. The computer readable instructions of the system of the present invention may utilize known modeling applications in the art, including IGES, STL, or OBJ file formats. Additionally other 3-D modeling or rendering file formats may be used, including but not limited to, STEP, VRML (wrl), Parasolid, 3D PDF, PLY, 3D S, 3D DXF, or native CAD formats: ProEngineer, SolidWorks, AutoCAD, Inventor, Unigraphics, Solid Edge, and Rhino 3D. The 3-D model is then opened within the application software of the system of the present invention, upon which the decorative materials may be electronically placed upon the 3-D surface of the electronic model of the desired product. This step may be repeated as necessary. Once completed, the resulting design is then saved in a placement file for loading into the automated assembly system having a computing device. Once the computer readable instructions are presented with the resulting design, the desired objects comprising decorative materials are then presented within the magazines, or feeders, as needed. The product, being an object as referenced herein, is then loaded into the system, as is the desired adhesive.

Once all components of the system are loaded, the user may then run the system. The first object—decorative material—position is determined, wherein the adhesive head places the adhesive on the product object, picks up the decorative material object and then places the decorative material object upon the product object. The system then reads the next position of the 3-D design loaded into the system for repeating these steps until the last decorative material object is placed upon the product object.

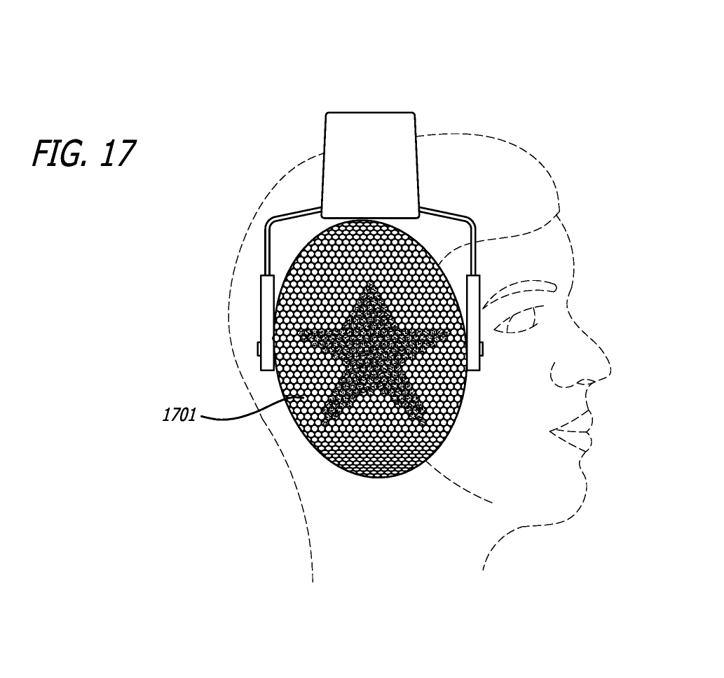

Referencing FIG. 17, the objects of interest, or products, are treated in accordance with the computer program instructions in carrying out the design features stored in the computer. The decorative materials 1701 may vary in color depending on the user preference, and design characteristics can be repeated based upon the stored design. In the embodiment described in FIG. 17, any object, such as a consumer product, may be treated by the system of the present invention by having the design stored in a computer print a predetermined design, which may have varying colors or shapes of decorative materials, affixed to the surface.

For the purposes of the present invention, the finished object may further be coated, polished, painted, or otherwise finished following the affixing step of the decorative materials. The decorative materials of the desired shape, optical qualities, and color, are affixed using an affixing step, and then allowed a required time to harden or cure. In another embodiment, a protective layer, which may comprise a liquid resin, epoxy, or other liquid transparent material, may then be then applied. The material is then allowed to harden and cure, thus providing enclosed decorative materials retaining a desired optical quality, while preserved against damage and wear, including but not limited to weather, vibration, ancillary impact, and general wear and tear.

Those skilled in the art will recognize that the methods and articles of the present invention may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently. While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. An apparatus for affixing decorative material on a three-dimensional object, comprising:
a. a robotic arm assembly having a placement head;
b. one or more retrieving heads extending from the placement head of the robotic arm assembly;
c. one or more adhesive heads extending from the placement head of the robotic arm assembly;
d. a base plate;
e. one or more magazines further comprising one or more decorative materials; and
f. a controller in electronic communication with the robotic arm assembly via a communication link further comprising a computing device, memory storing computer-executable instructions, and one or more processors.

2. The apparatus of claim 1, wherein the robotic arm assembly is a six-axis robotic arm.

3. The apparatus of claim 1, wherein the retrieving head assembly further comprises a vacuum assembly.

4. The apparatus of claim 1, wherein the adhesive head assembly further comprises a reservoir of adhesive.

5. The apparatus of claim 1, wherein the one or more magazines comprise different decorative materials.

6. The apparatus of claim 5, further comprising arrangement of the decorative materials in the magazine in an array having a predetermined location.

7. The apparatus of claim 5, further comprising the decorative materials located in the magazine in a feeder arrangement.

8. A method for placement of decorative materials on a three-dimensional object, comprising:
a. positioning a three-dimensional object on a base plate;
b. applying an adhesive to the three-dimensional object at a preconfigured location via a robotic arm assembly; and
c. affixing a decorative material to the three-dimensional object at said preconfigured location via the robotic arm assembly.

9. The method of claim 8, wherein the three-dimensional object is further secured into position on the base plate by a pedestal elevating the object off the base plate.

10. The method of claim 8, further comprising inputting a three-dimensional graphical model of the three-dimensional object into a controller comprising a computing device memory storing computer-executable instructions, and one or more processors for executing said computer-executable instructions for operating a robotic arm assembly.

11. The method of claim 10, further comprising placing graphical renderings of decorative materials onto the graphical model of the three-dimensional object.

12. The method of claim 8, wherein the application of the adhesive further comprises applying computationally-sized droplet located where one decorative material is to be attached.

13. The method of claim 8, wherein the application of the adhesive is to the entire three-dimensional object.

14. The method of claim 8, wherein the decorative material is obtained from a magazine located on a tray positioned within reach of the robotic arm.

15. A system, comprising:
a. a controller comprising a computing device, memory storing computer-executable instructions, and one or more processors for executing said computer-executable instructions for operating a robotic arm assembly for affixing adhesive and decorative materials onto a three-dimensional object, said operating occurring during performance of a preconfigured gesture that changes the position of the robotic arm assembly during the performance of the gesture;
b. a base plate for supporting a three-dimensional object and robotic arm assembly;
c. a magazine of decorative materials located upon said base plate; and
d. a robotic arm assembly comprising one or more retrieving heads and one or more adhesive heads, wherein the one or more adhesive heads are operable via the controller to affix adhesive at one or more desired locations upon the three-dimensional object, and wherein the one or more retrieving heads are operable via the controller to retrieve the decorative materials from the magazine and position the decorative materials on the desired location having adhesive applied.

16. The system of claim 15, wherein the robotic arm assembly is a six-axis robotic arm.

17. The system of claim 15, wherein the computer-executable instructions are a three-dimensional graphical model of the three-dimensional object.

18. The system of claim 15, wherein the computer-executable instructions further comprise user data input.

19. The system of claim 15, wherein the magazine of decorative materials is located in reach of the robotic arm assembly, wherein the robotic arm assembly is capable of retrieving the desired decorative materials via a retrieving head using computer-executable instructions for determining the location of the decorative materials.

20. The system of claim 19, further comprising more than one magazine comprising decorative materials.

21. The system of claim 15, wherein the adhesive is a computationally-sized droplet deposited on the three-dimensional object at the location of each decorative material.

22. The system of claim 15, wherein the adhesive is applied to the entire three-dimensional object prior to attachment of the decorative materials.
